(19) United States
(12) Patent Application Publication
(10) Pub. No.: US 2011/0081795 A1
(43) Pub. Date: Apr. 7, 2011

(54) CONTACT AND CONNECTOR

(75) Inventor: Kenichi Shimoji, Tokyo (JP)

(73) Assignee: Japan Aviation Electronics Industry, Limited, Tokyo (JP)

(21) Appl. No.: 12/843,195

(22) Filed: Jul. 26, 2010

(30) Foreign Application Priority Data
Oct. 6, 2009 (JP) 2009-232516

(51) Int. Cl. H01R 33/02

(52) U.S. Cl. 439/226

(57) ABSTRACT

A contact which is capable of preventing damage to a fluorescent tube due to a temperature change, and reducing the heights of the contact and the connector. The contact comprises a base portion, a contact portion that is brought into contact with an electrode of the fluorescent tube, a connecting portion that is continuous with the base portion and is connected to a printed circuit board, and a linkage portion that connects between the base portion and the contact portion such that the contact portion is movable in a longitudinal direction of the fluorescent tube. The base portion, the linkage portion, and the contact portion are arranged in a first direction that is orthogonal to a direction perpendicular to a plane on which the circuit board extends and the longitudinal direction.

### BACKGROUND OF THE INVENTION

1. Field of the Invention

This invention relates to a contact and a connector comprising the same.

2. Description of Related Art

Conventionally, there has been proposed a connector comprising a terminal, a fixed housing, a movable housing, and a lid (see Japanese Laid-Open Patent Publication (Kokai) No. 2008-204657, (Paragraph Nos. 0017, 0020, 0021, and 0024)).

The terminal includes a fixed portion, a lead supporting/fixing portion, a board contact portion, and an expansion/contraction accommodation portion. The fixed portion is fixed to the fixed housing. The lead supporting/fixing portion, which has a substantially tuning-fork shape, is in contact with a lead wire of a fluorescent tube, and supports the lead wire. The board contact portion is brought in contact with one portion of an inverter board. The expansion/contraction accommodation portion couples the fixed portion and the lead supporting/fixing portion to each other such that the lead supporting/fixing portion is movable in a longitudinal direction of the fluorescent tube.

The fixed housing accommodates the terminal, with the fixed portion of the terminal fixed thereto, and receives one portion of the inverter board.

The movable housing is movably mounted on the fixed housing.

The lid is pivotally mounted on the movable housing.

To electrically connect between the inverter board and the fluorescent tube by using the above-described connector, first, part of the inverter board is inserted into a board insertion opening of the fixed housing, to thereby cause the inverter board to be brought into contact with the board contact portion of the terminal.

Next, the lid is opened by pivoting the same, and the lead wire of the fluorescent tube is brought into contact with the lead supporting/fixing portion of the terminal from above the movable housing.

Then, the lid is closed by reversely pivoting the same. At this time, an inner surface of the lid presses the lead supporting/fixing portion, such that the lead wire is sandwiched between the inner surface of the lid and the lead supporting/fixing portion. As a result, the inverter board and the fluorescent tube are electrically connected to each other, whereby power is supplied from the inverter board to the fluorescent tube, causing the fluorescent tube to be lit.

When the fluorescent tube is lit, heat is produced in the fluorescent tube, and the fluorescent tube thermally expands in the longitudinal direction thereof due to the heat.

The expansion/contraction accommodation portion of the terminal expands in the longitudinal direction of the fluorescent tube in accordance with the thermal expansion of the fluorescent tube. As a result, the lead supporting/fixing portion of the terminal follows up the thermal expansion of the fluorescent tube, whereby occurrence of damage to the fluorescent tube is suppressed.

In the terminal of the above-described connector, the lead supporting/fixing portion, the expansion/contraction accommodation portion, the fixed portion, and the board contact portion are arranged along the height of the connector. This increases the size of the height of the terminal, making it difficult to reduce the height of the connector.

### SUMMARY OF THE INVENTION

The present invention has been made in view of these circumstances, and an object thereof is to prevent damage to a fluorescent tube due to a temperature change and to reduce the respective heights of a contact and a connector.

To attain the above object, in a first aspect of the present invention, there is provided a contact that electrically connects between an electrode of a fluorescent tube and a circuit board, comprising a base portion, a contact portion that is brought into contact with the electrode of the fluorescent tube, a connecting portion that is continuous with the base portion and is connected to the circuit board, and a linkage portion that connects between the base portion and the contact portion such that the contact portion is movable in a longitudinal direction of the fluorescent tube, the base portion, the linkage portion, and the contact portion being arranged in a first direction that is orthogonal to a direction perpendicular to a plane on which the circuit board extends and the longitudinal direction.

With the arrangement of the contact according to the first aspect of the present invention, the base portion, the linkage portion, and the contact portion are arranged in the first direction that is orthogonal to the direction perpendicular to the plane on which the circuit board extends and the longitudinal direction, whereby the size of the contact in a vertical direction thereof (the direction perpendicular to the plane on which the substrate extends) is reduced.

Preferably, the linkage portion has a plate shape, and a thickness direction of the linkage portion is parallel to the longitudinal direction.

More preferably, the linkage portion extends in the first direction, and a width of each end portion of the linkage portion is larger than a width of a central portion of the linkage portion.

Preferably, the central portion of the linkage portion is bent.

In a second aspect of the present invention, there is provided a connector comprising a contact that electrically connects between an electrode of a fluorescent tube and a circuit board, including a base portion, a contact portion that is brought into contact with the electrode of the fluorescent tube, a connecting portion that is continuous with the base portion and is connected to the circuit board, and a linkage portion that connects between the base portion and the contact portion such that the contact portion is movable in a longitudinal direction of the fluorescent tube, the base portion, the linkage portion, and the contact portion being arranged in a first direction that is orthogonal to a direction perpendicular to a plane on which the circuit board extends and the longitudinal direction, and a fixed housing that accommodates the contact and has the base portion fixed thereto.

Preferably, the connecting portion has a clip shape that sandwiches the circuit board in a thickness direction of the circuit board, and the fixed housing has a board insertion portion that receives therein a portion of the circuit board.

More preferably, the connector comprises a movable housing that is movably mounted to the fixed housing and adjusts a contact force between the contact portion and the electrode of the fluorescent tube.

According to the present invention, it is possible to prevent damage to the fluorescent tube due to a temperature change, and at the same time, reduce the respective heights of the contact and the connector.

The above and other objects, features and advantages of the present invention will become more apparent from the following detailed description taken in conjunction with the accompanying drawings.

### BRIEF DESCRIPTION OF THE DRAWINGS

FIG. 1 is a perspective view showing an in-use state of a connector according to a first embodiment of the present invention;

FIG. 2 is a front view of one of two contacts appearing in FIG. 1;

FIG. 3 is a plan view of the contact shown in FIG. 2;

FIG. 4 is a perspective view showing an in-use state of a connector according to a second embodiment of the present invention;

FIG. 5 is a perspective view showing an in-use state of a connector according to a third embodiment of the present invention;

FIG. 6 is a schematic view showing a state in which the connector shown in FIG. 5 is disposed on a backboard;

FIG. 7 is a perspective view of the connector shown in FIG. 5 in a state in which a fixed housing is removed therefrom;

FIG. 8 is a perspective view of contacts of the connector shown in FIG. 5;

FIG. 9 is a cross-sectional view of a connector according to a fourth embodiment of the present invention in a state in which a fluorescent tube is not connected thereto;

FIG. 10 is a cross-sectional view of the connector shown in FIG. 9 in a state in which a fluorescent tube is connected thereto;

FIG. 11 is a cross-sectional view taken along line XI-XI shown in FIG. 10;

FIG. 12 is a perspective view of the connector shown in FIG. 9 in a state in which contacts thereof are assembled to a fixed housing;

FIG. 13 is a perspective view of the contacts of the connector shown in FIG. 9;

FIG. 14 is a perspective view of a movable housing of the connector shown in FIG. 9;

FIG. 15 is a cross-sectional view showing a state in which a side portion of the fixed housing of the connector shown in FIG. 9 is cut off;

FIG. 16 is a perspective view showing a state in which the movable housing is provisionally locked in the fixed housing;

FIG. 17 is a perspective view showing a state in which the provisional locking of the movable housing is released; and

FIG. 18 is a perspective view showing a state in which the movable housing is locked in the fixed housing.

### DETAILED DESCRIPTION OF THE PREFERRED EMBODIMENTS

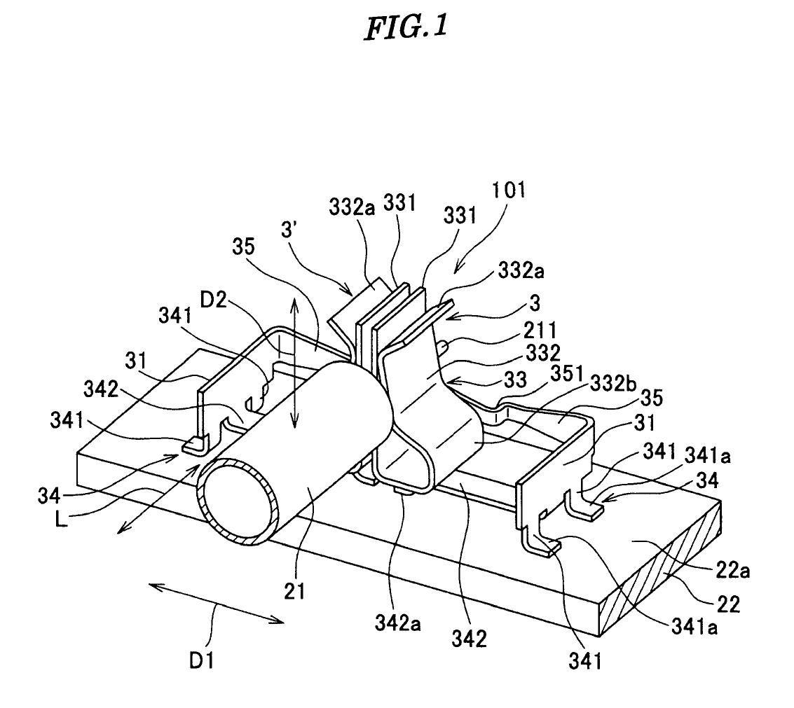

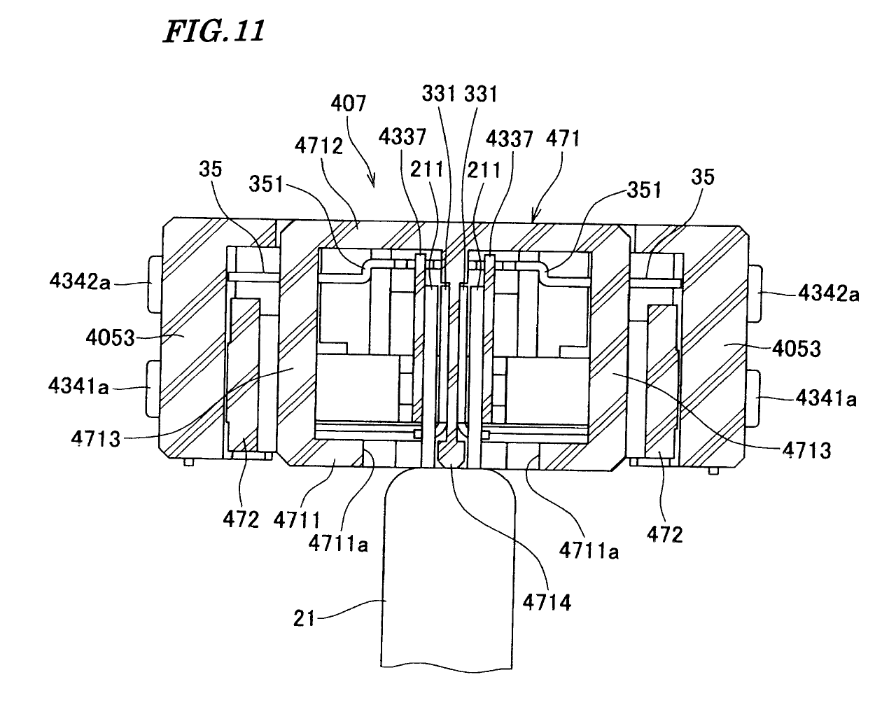

The present invention will now be described in detail with reference to the drawings showing preferred embodiments thereof. In FIGS. 1, 4, 5, 7, 8, 11, 13, 15, 16, 17, and 18, an entire fluorescent tube 21 is not depicted, but only one end portion of the fluorescent tube 21 is depicted. It should be noted that in embodiments described hereinafter, a longitudinal direction L of the fluorescent tube 21 is regarded as a front-rear direction of contacts 3, 3′, 303, 303′, 403, and 403′ or connectors 101, 201, 301, and 401; a direction (hereinafter referred to as the “vertical direction”) D2 perpendicular to flat surfaces 22a and 322a of printed circuit boards 22 and 322 as a vertical direction of the contacts 3, 3′, 303, 303′, 403, and 403′ or the connectors 301 and 401; and a first direction D1 that is orthogonal to the longitudinal direction L of the fluorescent tube 21 and the vertical direction D2 as a left-right direction of the contacts 3, 3′, 303, 303′, 403, and 403′ or the connectors 301 and 401.

Now, the connector 101 according to a first embodiment of the present invention will be described with reference to FIGS. 1 to 3.

As shown in FIG. 1, the connector 101 is comprised of a pair of contacts 3 and 3′, and the fluorescent tube 21 and the printed circuit board (circuit board) 22 are electrically connected to each other via the contacts 3 and 3′.

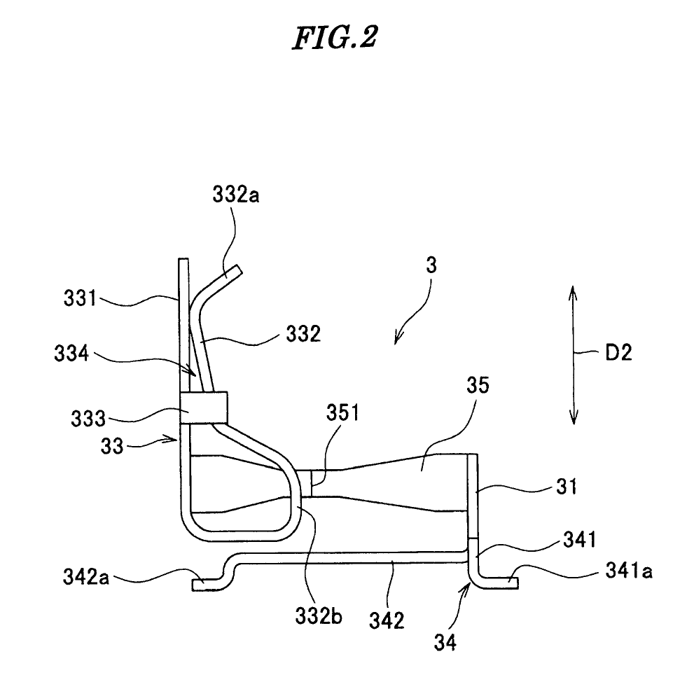

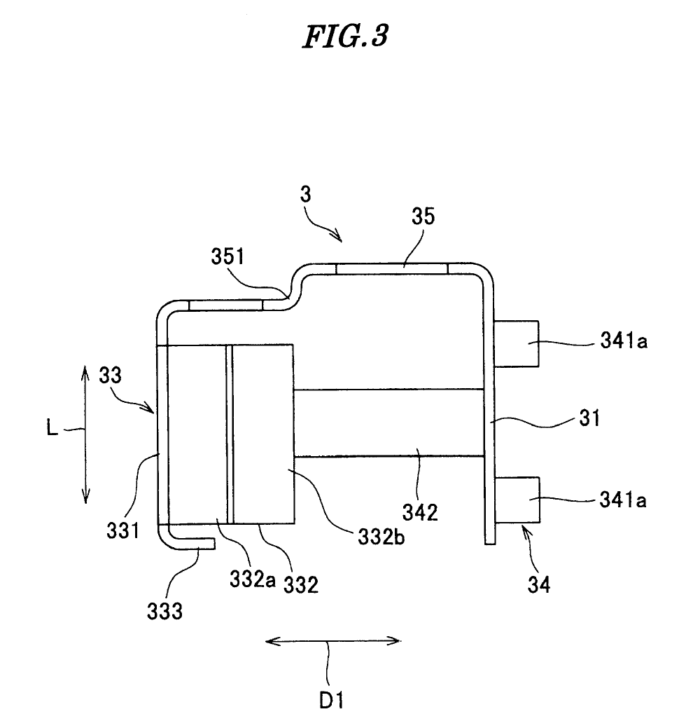

As shown in FIGS. 2 and 3, the contact 3 includes a base portion 31, a contact portion 33, a connecting portion 34, and a linkage portion 35. The contact 3 is formed by blanking and bending one metal plate having conductivity and elasticity.

The base portion 31 has a substantially plate shape. The base portion 31 extends in the longitudinal direction L of the fluorescent tube 21.

The contact portion 33 sandwiches an electrode 211 (see FIG. 1) of the fluorescent tube 21. The contact portion 33 includes a first contact portion 331, a second contact portion 332, and a positioning portion 333. The first contact portion 331 has a flat plate shape. The second contact portion 332 has a substantially S-shape and includes a guiding portion 332a and a spring portion 332b. The guiding portion 332a is inclined with respect to the first contact portion 331. The guiding portion 332a guides the electrode 211 into an electrode-holding space 334, referred to hereinafter. A lower portion of the guiding portion 332a is always urged against the first contact portion 331 by the spring force of the spring portion 332b. An upper portion of the spring portion 332b is continuous with the lower portion of the guiding portion 332a, and a lower portion of the spring portion 332b is continuous with a lower end of the first contact portion 331. The positioning portion 333 is continuous with an intermediate portion of the first contact portion 331 and extends in the first direction D1. A space formed between a portion of the first contact portion 331 above the positioning portion 333 and a portion of the second contact portion 332 above the positioning portion 333 is the electrode-holding space 334. The electrode 211 (see FIG. 1) of the fluorescent tube 21 is received in the electrode-holding space 334. When the electrode 211 is received in the electrode-holding space 334, the electrode 211 is sandwiched between the first and second contact portions 331 and 332, and at the same time, supported by the positioning portion 333, whereby the electrode 211 is positioned in the vertical direction D2.

The connecting portion 34 is comprised of two first connecting portions 341 and 341 and one second connecting portion 342. Each of the two first connecting portions 341 and 341 is bent into a substantially L-shape, whereas the second connecting portion 342 is bent into a substantially crank shape. The first connecting portions 341 and 341 and the second connecting portion 342 are each continuous with a lower portion of the base portion 31. One of the two first connecting portions 341 and 341 is located at a front portion of the base portion 31, the other at a rear portion of the base portion 31, and the second connecting portion 342 at an intermediate portion of the base portion 31. Each first connecting portion 341 includes a soldering portion 341a. The second connecting portion 342 includes a soldering portion 342a. The soldering portions 341a and 342a are soldered onto respective associated pads (not shown) of the printed circuit board 22 (see FIG. 1).

The linkage portion 35 connects between the base portion 31 and the contact portion 33 such that the contact portion 33 is movable in the longitudinal direction L of the fluorescent tube 21. The linkage portion 35 has a plate shape and extends in the first direction D1 that is perpendicular to the vertical direction D2 and the longitudinal direction L. The thickness direction of the linkage portion 35 is parallel to the longitudinal direction L. A width (i.e. a length in the vertical direction D2) of each end portion of the linkage portion 35 is larger than a width (i.e. a length in the vertical direction D2) of a central portion of the linkage portion 35. Further, the central portion in the first direction D1 of the linkage portion 35 is bent into a crank shape, thereby forming a bent portion 351 in the linkage portion 35.

As shown in FIGS. 2 and 3, the base portion 31, the linkage portion 35, and the contact portion 33 are arranged in the first direction D1.

The shape of the contact 3′ is the same as the shape of the contact 3 as seen reflected in a mirror (i.e. a shape where the left and the right of the contact 3 are reversed). Therefore, component parts corresponding to those of the contact 3 are denoted by the same reference numerals, and detailed description of the contact 3′ is omitted.

The soldering portions 341a and 342a of the first and second connecting portions 341 and 342 of the contacts 3 and 3′ are soldered onto respective associated pads of the printed circuit board 22 by using a method such as reflow soldering, whereby the contacts 3 and 3′ are mounted on the printed circuit board 22.

As shown in FIG. 1, a pair of electrodes 211 (only one electrode 211 of the pair can be seen in FIG. 1) in one end portion of the fluorescent tube 21 are connected to the contacts 3 and 3′, whereas a pair of electrodes (not shown) in the other end portion of the fluorescent tube 21 are connected to contacts (not shown) that are disposed on an other end portion side of the fluorescent tube 21 and have the same structure as that of the contacts 3 and 3′.

Next, a description will be given of usage and functions of the contacts 3 and 3′.

First, the soldering portions 341a and 342a of the first and second connecting portions 341 and 342 of the contacts 3 and 3′ are soldered onto the respective associated pads of the printed circuit board 22.

Next, the electrodes 211 and 211 of the fluorescent tube 21 are inserted into the contacts 3 and 3′, respectively, each between the first contact portion 331 and the second contact portion 332, and are each brought into abutment with the positioning piece 333. When each electrode 211 is inserted between the first contact portion 331 and the second contact portion 332, the electrode 211 is guided into the electrode-holding space 334 by the guiding portion 332a of the second contact portion 332. The electrode 211 received in the electrode-holding space 334 is sandwiched between the first and second contact portions 331 and 332, and at the same time, supported by the positioning portion 333, whereby the electrode 211 is positioned in the vertical direction D2.

Since each second contact portion 332 is always urged against the associated first contact portion 331, a large contact force is generated between the electrode 211 and the contact portion 33, whereby the electrode 211 received in the electrode-holding space 334 is reliably sandwiched between the first contact portion 331 and the second contact portion 332.

When the electrodes 211 are received in the electrode-holding spaces 334, the printed circuit board 22 and the fluorescent tube 21 are electrically connected to each other, whereby power is supplied from the printed circuit board 22 to the fluorescent tube 21, causing the fluorescent tube 21 to be lit.

During lighting of the fluorescent tube 21, when heat is produced in the fluorescent tube 21 and the fluorescent tube 21 thermally expands in the longitudinal direction L thereof due to the heat, the linkage portions 35 and 35 of the contacts 3 and 3′ are flexed in accordance with the amount of such thermal expansion, and the contact portions 33 and 33 follow up the thermal expansion of the fluorescent tube 21.

When the fluorescent tube 21 is turned off, the fluorescent tube 21 contracts in the longitudinal direction L thereof due to decrease in the temperature of the fluorescent tube 21, the linkage portions 35 and 35 of the contacts 3 and 3′ return to their original states, and the contact portions 33 and 33 follow up the contraction of the fluorescent tube 21.

During the expansion/contraction of the fluorescent tube 21, the linkage portions 35 and 35 of the contacts 3 and 3′ become deformed. However, the width of each end portion of each linkage portion 35 is larger than the width of the central portion of the linkage portion 35, and moreover, since the bent portion 351 is formed in the central portion of the linkage portion 35, when the linkage portion 35 is deformed, stress is applied also to the bent portion 351 of the central portion of the linkage portion 35, thereby making it possible to prevent stress concentration at each end portion of the linkage portion 35.

According to the first embodiment, the base portions 31, the linkage portions 35, and the contact portions 33 are in side-by-side arrangement in the first direction D1, which makes it possible to reduce the respective heights of the contacts 3 and 3′.

Further, when the fluorescent tube 21 expands or contracts due to a temperature change and the electrodes 211 move in the longitudinal direction L, the linkage portions 35 of the contacts 3 and 3′ are deformed in the longitudinal direction L, whereby the contact portions 33 follow up the movement of the electrodes 211, making it possible to prevent damage to the fluorescent tube 21.

Further, since the linkage portions 35 have a plate shape, compared to an expansion/contraction accommodation portion having a zigzag shape of a conventional connector terminal, it is not necessary to prevent undesired deformation of the linkage portions 35 by using e.g. a jig during bending work on the contacts 3 and 3′. This means that the bending work on the contacts 3 and 3′ is made easy, whereby it is possible to improve productivity.

Also, since the width of each end portion of each linkage portion 35 is larger than the width of the central portion of the linkage portion 35, it is possible to prevent stress concentration at each end portion of the linkage portion 35, thereby making it possible to prevent plastic deformation of the contacts 3 and 3′.

Further, since the bent portion 351 is formed in the central portion of each linkage portion 35, stress is applied also to the bent portion 351 when the linkage portion 35 is flexed. Therefore, it is possible to prevent stress concentration at each end portion of the linkage portion 35, thereby making it possible to prevent plastic deformation of the contacts 3 and 3′.

Also, since a preload is applied to each second contact portion 332 such that the second contact portion 332 is always urged against the associated first contact portion 331, when the electrode 211 is inserted between the first contact portion 331 and the second contact portion 332, a large contact force is generated. Therefore, it is possible to make the contacts 3 and 3′ compact in size, and at the same time it is possible to improve contact stability between the electrodes 211 and the contact portions 33.

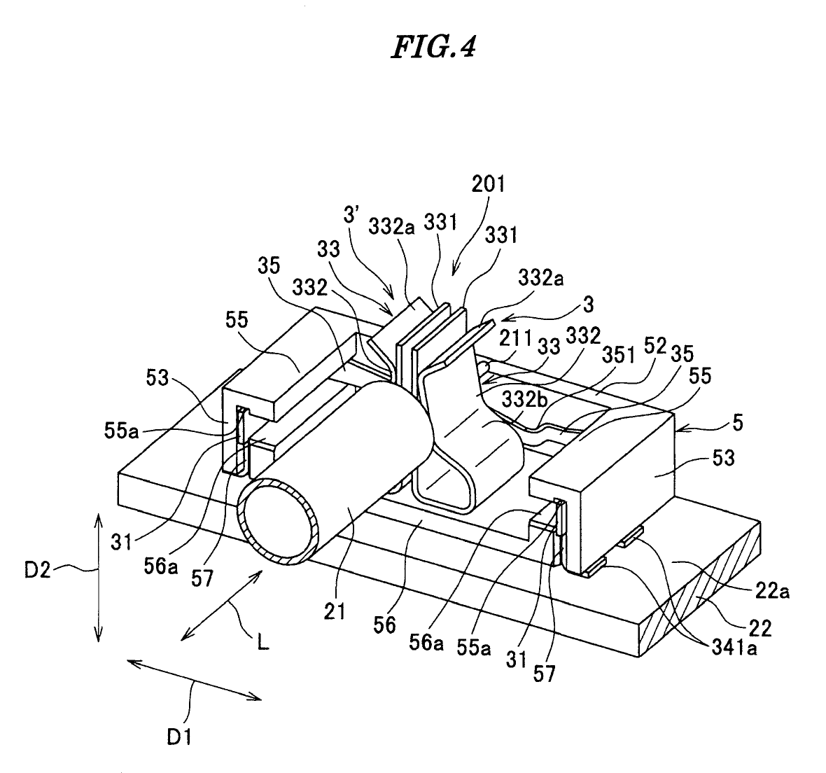

Next, a description will be given of a connector according to a second embodiment of the present invention with reference to FIG. 4. Component parts corresponding to those of the first embodiment are denoted by the same reference numerals, and detailed description thereof is omitted.

As shown in FIG. 4, the connector 201 according to the second embodiment comprises the contacts 3 and 3′, and a fixed housing 5.

The fixed housing 5 accommodates the contacts 3 and 3′. The fixed housing 5 is integrally formed of an insulating material such as resin, and includes a rear portion 52, side portions 53 and 53, top portions 55 and 55, and a bottom portion 56.

A slit 57 that extends in the front-rear direction is formed between each of the side portions 53 and 53 and the bottom portion 56. A groove 55a that extends in the front-rear direction is formed in a lower surface of each top portion 55. A holding portion 56a that has a protruding shape and extends in the front-rear direction is formed on each side portion of the bottom portion 56.

To assemble the connector 201, portions of the first and second connecting portions 341 and 342 (see FIG. 1) of the contacts 3 and 3′ except for the soldering portions 341a and 342a (see FIG. 1) are press-fitted into the slits 57. As a result, the contacts 3 and 3′ are fixed to the fixed housing 5. The holding portions 56a of the bottom portion 56 hold the portions of the first and second connecting portions 341 and 342 except for the soldering portions 341a and 342a such that the portions are not detached from the side portions 53. An upper portion of each base portion 31 of the contacts 3 and 3′ is inserted into an associated one of the grooves 55a of the upper portions 55.

By soldering the soldering portions 341a and 342a of the contacts 3 and 3′ onto the printed circuit board 22, the connector 201 is mounted on the printed circuit board 22.

According to the second embodiment, the same advantageous effects as those provided by the first embodiment are obtained, and at the same time it is possible to attract the top portions 55 and 55 of the fixed housing 5 by suction using a nozzle or nozzles of a suction-type conveying apparatus, not shown, whereby the connector 201 can easily be disposed on the printed circuit board 22. Further, since two contacts 3 and 3′ are assembled to a single fixed housing 5, it is possible to handle the two contacts 3 and 3′ as a single unit, whereby workability is improved.

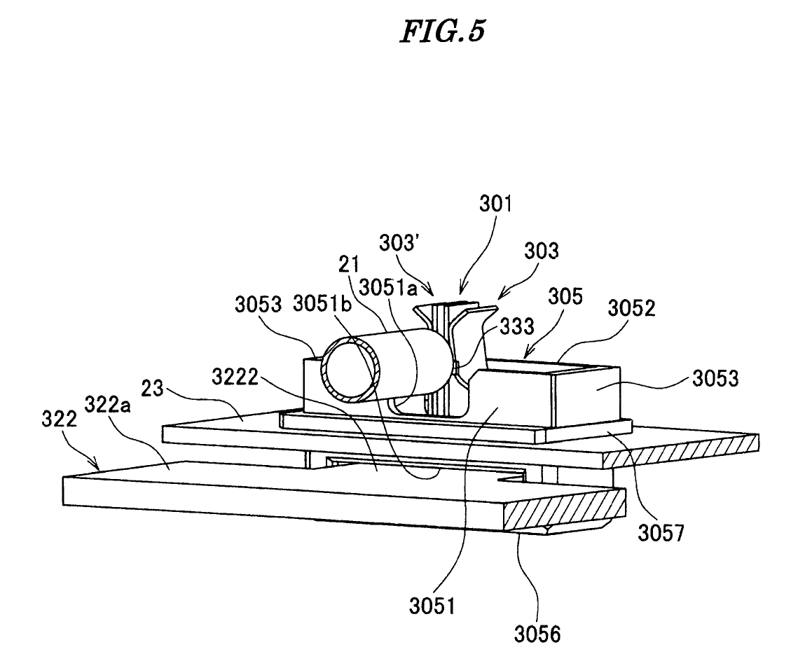

Next, a description will be given of a connector according to a third embodiment of the present invention with reference to FIGS. 5 to 8. Component parts corresponding to those of the first embodiment are denoted by the same reference numerals, and detailed description thereof is omitted.

As shown in FIG. 5, the connector 301 according to the third embodiment comprises the contacts 303 and 303′, and a fixed housing 305.

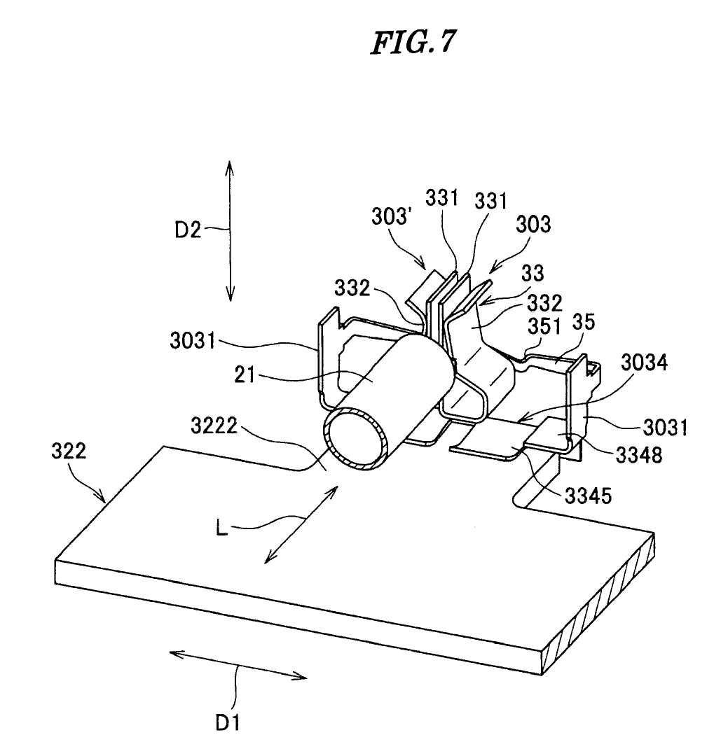

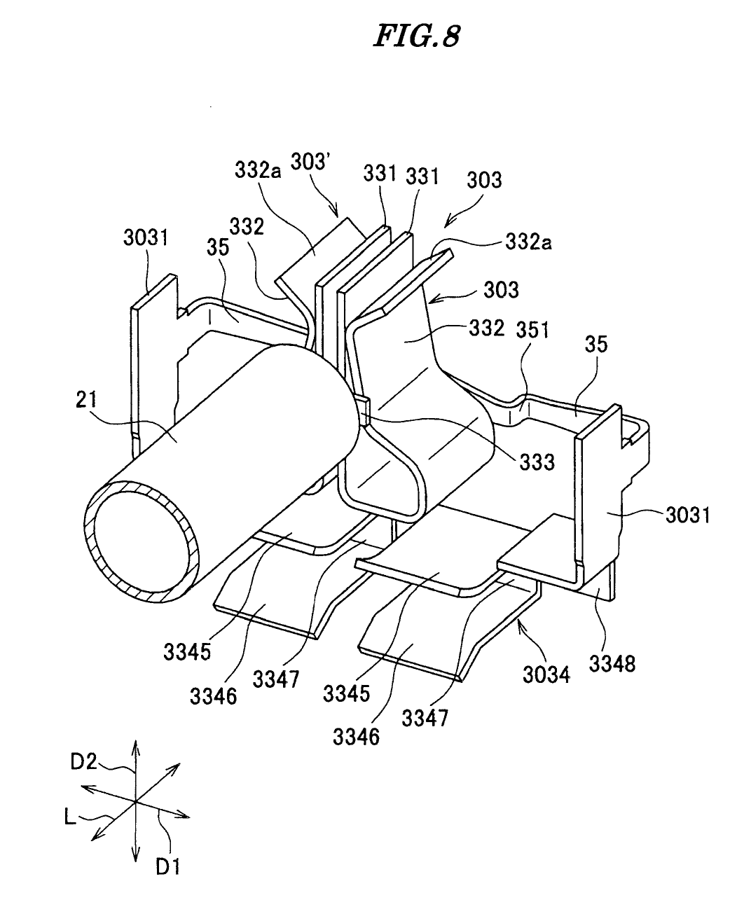

As shown in FIGS. 7 and 8, a base portion 3031 of the contact 303 extends in the vertical direction D2. A connecting portion 3034 sandwiches an insertion portion 3222 of the printed circuit board (circuit board) 322. The connecting portion 3034 has a clip shape and includes a first spring portion 3345, a second spring portion 3346, a first linkage portion 3347, and a second linkage portion 3348. The first spring portion 3345 is brought into contact with an upper surface of the insertion portion 3222. The second spring portion 3346 is brought into contact with a lower surface of the insertion portion 3222. The first linkage portion 3347 connects between the first spring portion 3345 and the second spring portion 3346. The second linkage portion 3348 connects between the first linkage portion 3347 and the base portion 3031. It should be noted that the shape of the contact 303′ is the same as the shape of the contact 303 as seen reflected in a mirror (i.e. a shape where the left and the right of the contact 303 are reversed). Therefore, component parts corresponding to those of the contact 303 are denoted by the same reference numerals, and detailed description of the contact 303′ is omitted.

As shown in FIG. 5, the fixed housing 305 in the form of a box with an open top. The fixed housing 305 receives therein the contacts 303 and 303′, and the insertion portion 3222 of the printed circuit board 322. The fixed housing 305 includes a front portion 3051, a rear portion 3052, side portions 3053 and 3053, and a bottom portion 3056. A cutout 3051a is formed in an upper portion of the front portion 3051. The cutout 3051a prevents interference between the front portion 3051 and the fluorescent tube 21. A board insertion portion 3051b is formed in a lower portion of the front portion 3051. The board insertion portion 3051b receives the insertion portion 3222 of the printed circuit board 322. A collar portion 3057 is formed on an outer peripheral surface of the fixed housing 305.

To assemble the connector 301, it is only required to fix the base portions 3031 of the contacts 303 and 303′ to the fixed housing 305.

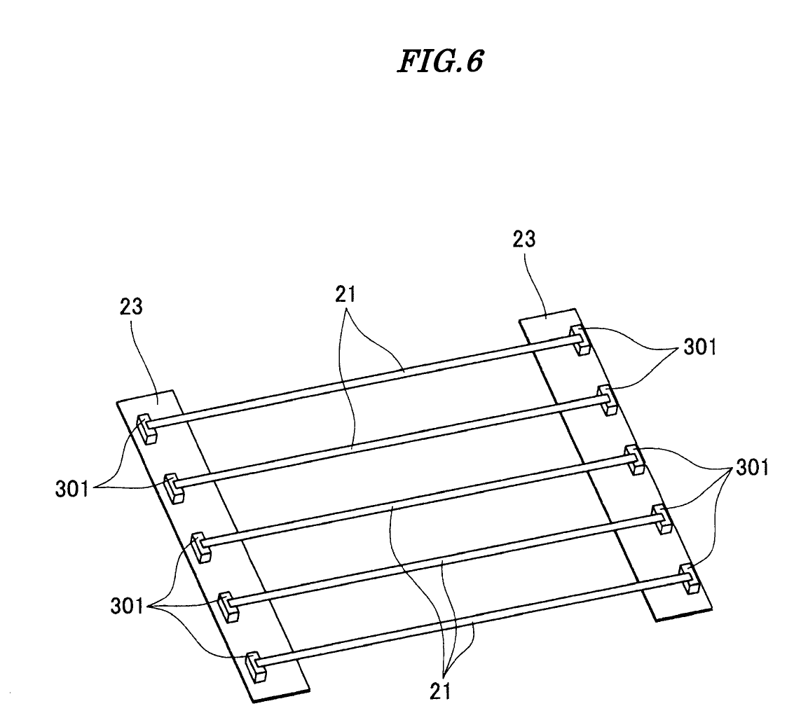

Next, a description will be given of usage of the connector 301. First, as shown in FIGS. 5 and 6, a lower portion of the fixed housing 305 is inserted into a window hole (not shown) formed in a backboard 23 made from metal or resin, and the collar portion 3057 of the fixed housing 305 is fixed to a peripheral portion of the window hole of the backboard 23.

Next, the insertion portion 3222 of the printed circuit board 322 is inserted into the board insertion portion 3051b of the front portion 3051. When the insertion portion 3222 is inserted into the board insertion portion 3051b, the insertion portion 3222 is vertically sandwiched between the first spring portions 3345 and the second spring portions 3346 of the connecting portions 3034 (see FIG. 7).

Finally, the two electrodes 211 of the fluorescent tube 21 are inserted into the contacts 303 and 303′, respectively, each between the first contact portion 331 and the second contact portion 332. When the electrodes 211 are inserted between the first contact portions 331 and the second contact portions 332, the electrodes 211 are guided downward by the guiding portions 332a of the second contact portions 332 to be brought into abutment with the positioning pieces 333.

According to the third embodiment, the same advantageous effects as those provided by the first embodiment are obtained, and at the same time it is possible to fix the contacts 303 and 303′ to the backboard 23 by using the fixed housing 305. Further, since the connecting portions 3034 of the contacts 303 and 303′ sandwich the insertion portion 3222 of the printed circuit board 322, it is possible to connect the connector 301 to the printed circuit board 322 without performing soldering.

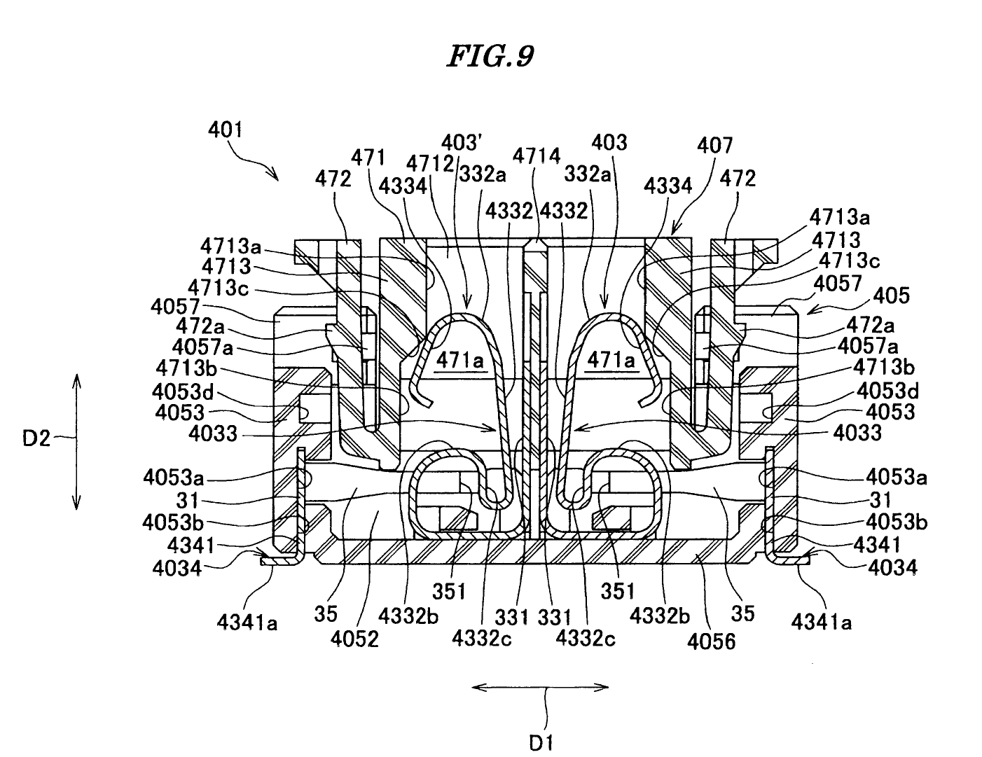

Next, a description will be given of a connector according to a fourth embodiment of the present invention with reference to FIGS. 9 to 18. Component parts identical to those of the first embodiment are denoted by the same reference numerals, and detailed description thereof is omitted.

As shown in FIG. 9, the connector 401 according to the fourth embodiment comprises the contacts 403 and 403′, a fixed housing 405, and a movable housing 407. It should be noted that the shape of the contact 403′ is the same as the shape of the contact 403 as seen reflected in a mirror (i.e. a shape where the left and the right of the contact 403 are reversed). Therefore, component parts corresponding to those of the contact 403 are denoted by the same reference numerals, and detailed description of the contact 403′ is omitted.

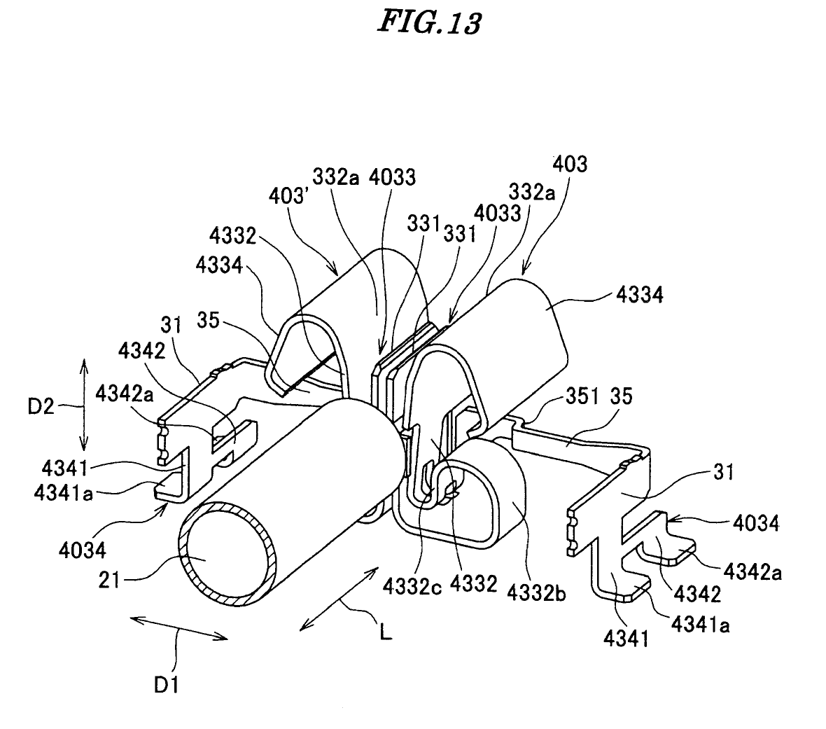

As shown in FIG. 13, a contact portion 4033 of the contact 403 is comprised of the first contact portion 331 and a second contact portion 4332. An engaging portion 4334 that has a substantially C-shape is continuous with the guiding portion 332a of the second contact portion 4332. A spring portion 4332b of the second contact portion 4332 includes a bent portion 4332c that is bent into a substantially U-shape. The spring length of the spring portion 4332b is increased by the bent portion 4332c. No preload is applied to the second contact portion 4332.

A connecting portion 4034 of the contact 403 is comprised of a first connecting portion 4341 and a second connecting portion 4342. The first connecting portion 4341 includes a soldering portion 4341a. The first connecting portion 4341 is continuous with the lower portion of the base portion 31. The second connecting portion 4342 includes a soldering portion 4342a. The second connecting portion 4342 is continuous with the first connecting portion 4341.

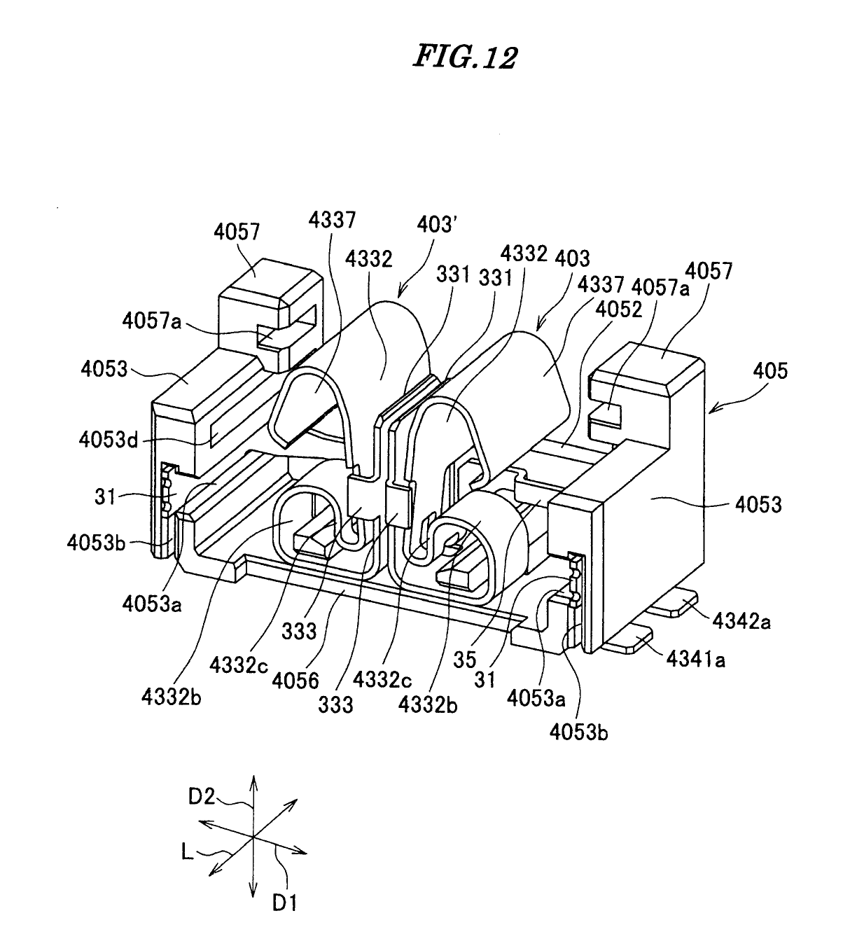

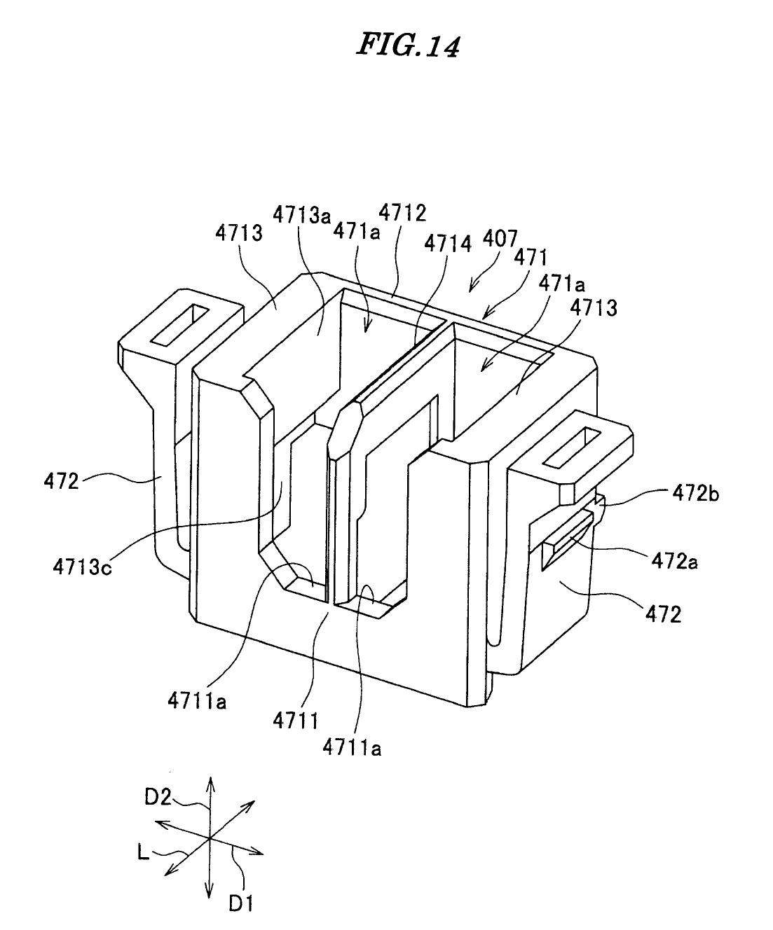

As shown in FIGS. 9 and 12, the fixed housing 405 includes a rear portion 4052, side portions 4053 and 4053, and a bottom portion 4056. A lower portion of a rear portion 4712 (see FIG. 14) of the movable housing 407 described hereinafter is brought into contact with the rear portion 4052, whereby excessive deformation of the linkage portions 35 of the contacts 403 and 403′ in the longitudinal direction L is prevented. A recess 4053a is formed in an inner surface of an intermediate portion in the vertical direction of each side portion 4053. The recess 4053a extends in the longitudinal direction L, and one end of the recess 4053a reaches a front surface of the fixed housing 405. A press-fitting groove 4053b is formed in a lower portion of each side portion 4053. The press-fitting groove 4053b leads to the recess 4053a. The press-fitting groove 4053b extends in the longitudinal direction L, and one end of the press-fitting groove 4053b reaches the front surface of the fixed housing 405. A locking groove 4053d is formed in an inner surface of an upper portion of each side portion 4053. The locking groove 4053d extends in the longitudinal direction L.

A prism-shaped portion 4057 is formed on the upper portion of each side portion 4053. The prism-shaped portion 4057 is located in a rear portion of the side portion 4053. A recess 4057a is formed in an inner surface of the prism-shaped portion 4057, and one end of the recess 4057a reaches a front surface of the prism-shaped portion 4057.

As shown in FIGS. 9, 14, and 15, the movable housing 407 includes a movable housing body 471 and a pair of locking arms 472. The movable housing 407 is mounted on the fixed housing 405 in a manner movable in the vertical direction D2 and the longitudinal direction L. The movable housing 407 adjusts a contact force between the contact portions 4033 of the contacts 403 and 403′ and the electrodes 211 of the fluorescent tube 21.

The movable housing body 471 has a substantially hollow rectangular prism shape and includes a front portion 4711, the rear portion 4712, side portions 4713 and 4713, and a partition 4714. A pair of cutouts 4711a are formed in the front portion 4711. The cutouts 4711a prevent interference between the front portion 4711 and the electrodes 211 of the fluorescent tube 21. Each side portion 4713 has an inner surface formed with a pressing surface 4713a, a non-contact surface 4713b, and an inclined surface 4713c (see FIG. 9). The inclined surface 4713c connects between the pressing surface 4713a and the non-contact surface 4713b. The partition 4714 partitions the space within the movable housing 407 into two contact electrode-accommodating spaces 471a.

A lower portion of each locking arm 472 is continuous with a lower portion of the movable housing body 471. There is a gap between a portion of the locking arm 472 other than the lower portion thereof and an outer surface of the movable housing body 471, and the portion of the locking arm 472 other than the lower portion thereof is deformable in the first direction D1. A locking lug 472a is formed on an outer-side side surface of the locking arm 472. Also, a protruding portion 472b is formed on a rear surface of the locking arm 472 (see FIG. 14).

Next, a description will be given of how to assemble the connector 401. First, the respective base portions 31 of the contacts 403 and 403′ and portions of the connecting portions 4034 except for the soldering portions 4341a and 4342a are press-fitted into the press-fitting grooves 4053b of the side portions 4053, respectively, from the front of the fixed housing 405 to fix the contacts 403 and 403′ to the fixed housing 405. At this time, interference between the linkage portions 35 and the fixed housing 405 is prevented by the concave portions 4053a (see FIG. 12).

After the contacts 403 and 403′ are fixed to the fixed housing 405, the movable housing 407 is inserted into the fixed housing 405 from above. When the protruding portions 472b of the locking arms 472 of the movable housing 407 reach the locations of the recesses 4057a of the prism-shaped portions 4057 of the fixed housing 405, the protruding portions 472b are fitted into the recesses 4057a, whereby the movable housing 407 is provisionally locked in the fixed housing 405.

By fitting the protruding portions 472b into the recesses 4057a, the assembly of the movable housing 407 to the fixed housing 405 is completed. At this time, as shown in FIG. 9, an upper portion of each contact portion 4033 of the contacts 403 and 403′ is accommodated in the associated one of the contact electrode-accommodating spaces 471a of the movable housing 407. Also, a lower end of each pressing surface 4713a of the movable housing 407 is brought into contact with the associated one of the engaging portions 4334 of the contacts 403 and 403′. The non-contact surfaces 4713b of the movable housing 407 are not brought into contact with the contacts 403 and 403′.

Next, a description will be given of usage and functions of the connector 401.

First, the connector 401 is mounted on a printed circuit board (not shown). The connector 401 is mounted on the printed circuit board by soldering the soldering portions 4341a of the contacts 403 and 403′ fixed to the fixed housing 405, onto the printed circuit board. When the connector 401 is mounted on the printed circuit board, the movable housing 407 is in a provisionally locked position (see FIG. 9).

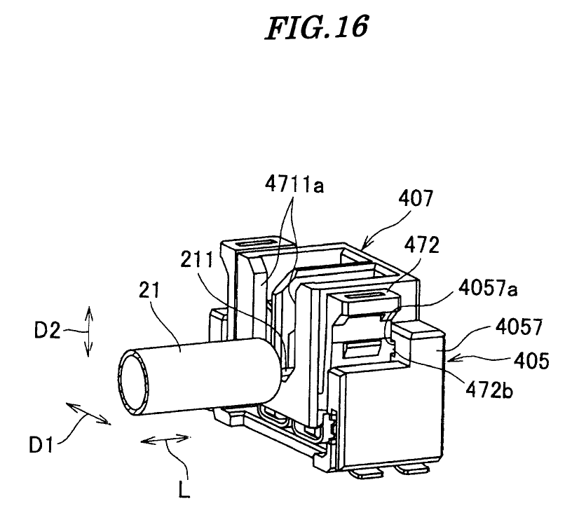

Next, the electrodes 211 of the fluorescent tube 21 are inserted respectively between the first contact portions 331 and the second contact portions 4332 that form the respective contact portions 4033 of the contacts 403 and 403′. As shown in FIG. 16, the cutouts 4711a are formed in the movable housing 407, whereby interference between the movable housing 407 and the electrodes 211 are prevented.

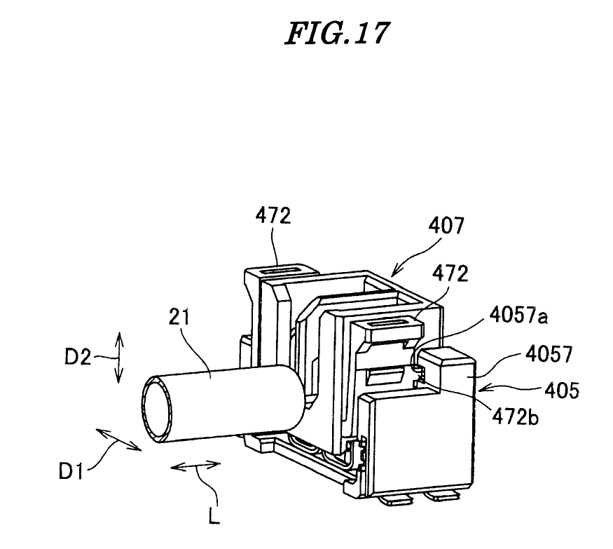

Then, as shown in FIG. 17, the movable housing 407 is caused to slide forward (leftward in FIG. 17) against the spring forces of the linkage portions 35 (see FIG. 9) to thereby remove the protruding portions 472b of the movable housing 407 from the recesses 4057a of the fixed housing 405.

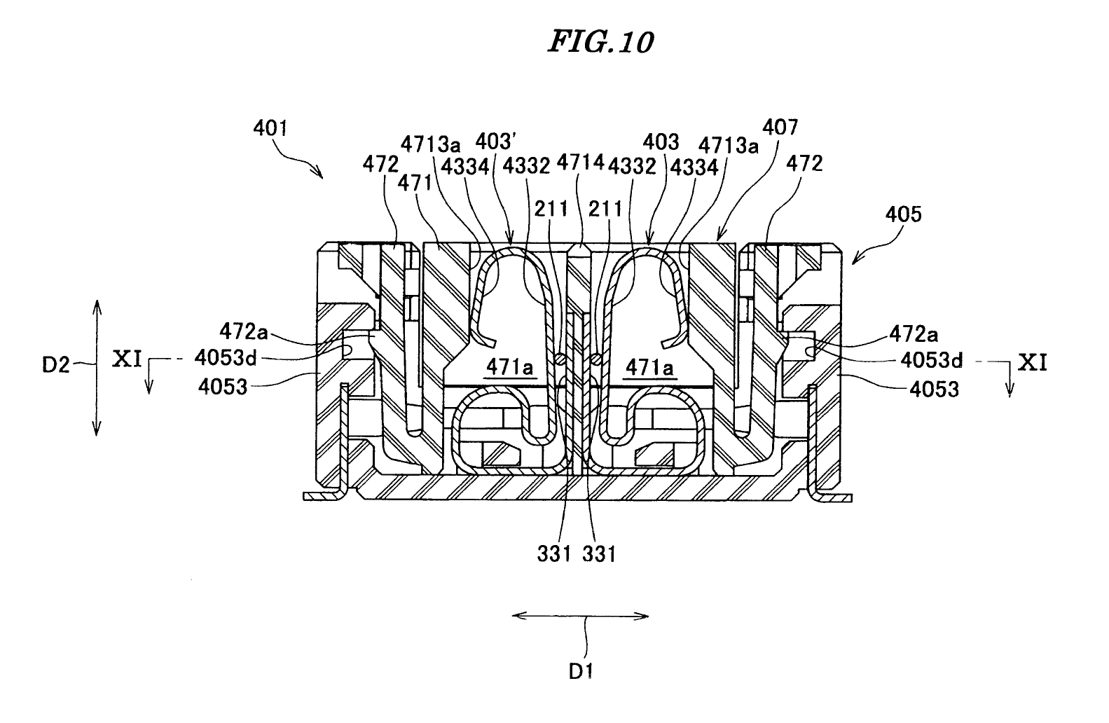

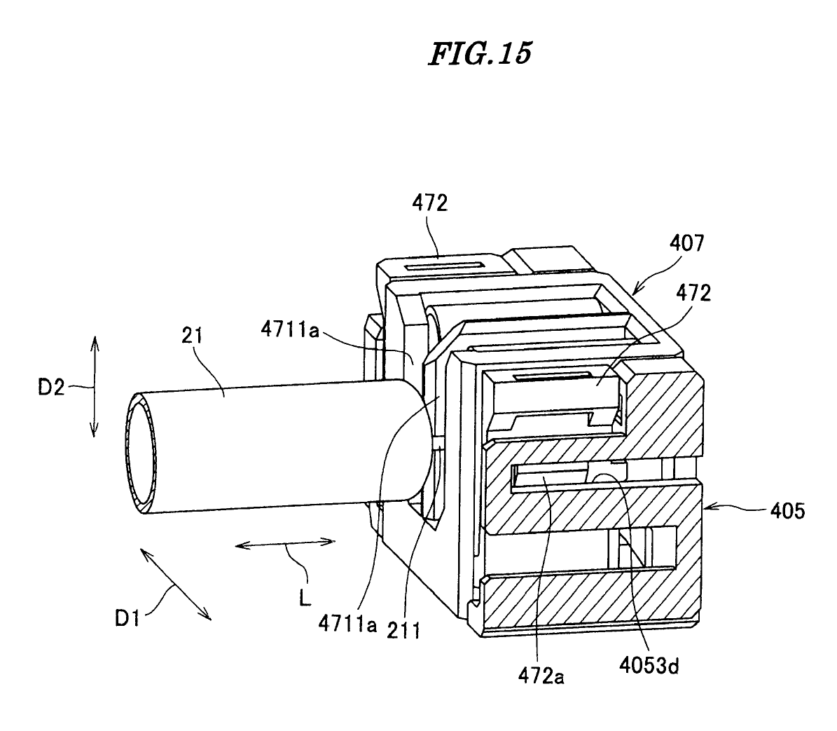

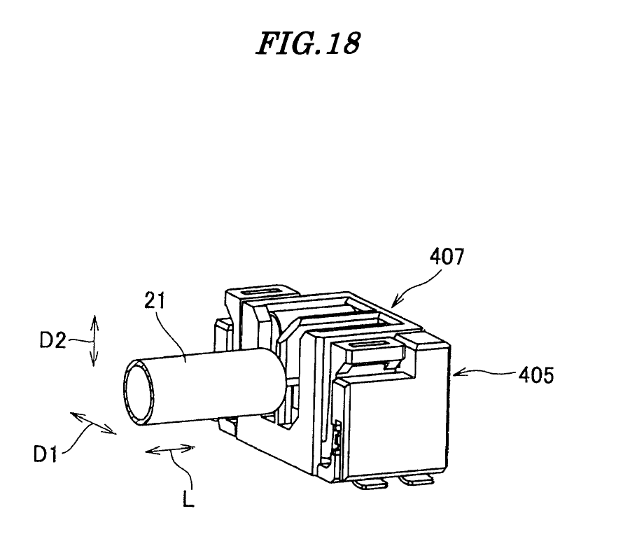

Finally, as shown in FIG. 18, the movable housing 407 is pressed downward into the fixed housing 405. When the movable housing 407 is pressed downward, the locking arms 472 of the movable housing 407 are flexed toward the movable housing body 471, causing the locking lugs 472a to climb on the inner surfaces of the side portions 4053 of the fixed housing 405. Then, as shown in FIGS. 10 and 15, the locking lugs 472a of the locking arms 472 are fitted into the locking grooves 4053d of the side portions 4053, whereby the movable housing 407 is locked in the fixed housing 405. Also, the pressing surfaces 4713a of the movable housing 407 urge the engaging portions 4334 of the contacts 403 and 403′, and the second contact portions 4332 urge the electrodes 211 against the first contact portions 331. As a result, the contact portions 4033 of the contacts 403 and 403′ are brought into tight contact with the electrodes 211 of the fluorescent tube 21, whereby the fluorescent tube 21 and the printed circuit board are electrically connected to each other.

To remove the fluorescent tube 21 from the connector 401, first, the locking arms 472 of the movable housing 407 are tilted toward the movable housing body 471, thereby removing the locking lugs 472a from the locking grooves 4053d, and then the movable housing 407 is pulled upward. The protruding portions 472b of the movable housing 407 that is pulled upward are fitted into the recesses 4057a of the fixed housing 405 (see FIG. 16) by the spring forces of the linkage portions 35 of the contacts 403 and 403′, whereby the movable housing 407 is provisionally locked in the fixed housing 405. At this time, as shown in FIG. 9, the second contact portions 4332 of the contacts 403 and 403′ are in respective states moved away from the first contact portions 331, so that the electrodes 211 of the fluorescent tube 21 are no longer sandwiched by the contact portions 4033, whereby it is possible to easily pull out the fluorescent tube 21 from the connector 401.

According to the fourth embodiment, the same advantageous effects as those provided by the first embodiment are obtained, and at the same time it is possible to attract the upper surfaces of the fixed housing 405 or the movable housing 407 by suction using a suction-type conveying apparatus, not shown, whereby the connector 401 can be disposed on the printed circuit board (not shown). Further, it is possible to handle the two contacts 403 and 403′ as a single unit.

Further, when the movable housing 407 is placed in a state temporarily locked to the fixed housing 405 (see FIG. 9), the electrodes 211 of the fluorescent tube 21 are no longer sandwiched by the contact portions 4033 of the contacts 403 and 403′, whereby it is possible to easily insert and remove the fluorescent tube 21 in and from the connector 401.

Further, when the movable housing 407 is lowered from the temporarily locked position shown in FIG. 9 to a locked position shown in FIG. 10, the movable housing 407 is locked in the fixed housing 405, whereby the movable housing 407 is made difficult to be detached upward. At the same time, since the state in which the contact portions 4033 of the contacts 403 and 403′ tightly sandwich the electrodes 211 of the fluorescent tube 21 is maintained, it is possible to obtain high contact stability between the contact portions 4033 and the electrodes 211.

It should be noted that although in the above-described embodiments, each linkage portion 35 has a plate shape and the thickness direction of the linkage portion 35 is made parallel to the longitudinal direction L, the linkage portion may be formed into e.g. a columnar shape.

Further, although in the above-described embodiments, the width of each end portion of each linkage portion 35 is made larger than the width of the central portion thereof, the width of the linkage portion may be equal to that of the central portion.

It should be noted that although in the above-described embodiments, the central portion of each linkage portion 35 is bent, the central portion of the linkage portion 35 may not be bent.

Further, although in the above-described embodiments, the connectors 101, 201, 301, and 401 are used for electrically connecting between the fluorescent tube 21 including two electrodes 211 in each end portion thereof (e.g. a hot-cathode fluorescent tube) and the printed circuit boards 22 and 322, the connectors according to the present invention may be applied to electrical connection between a fluorescent tube including one electrode in each end portion thereof (e.g. a cold-cathode fluorescent tube) and a printed circuit board.

It is further understood by those skilled in the art that the foregoing are the preferred embodiments of the present invention, and that various changes and modification may be made thereto without departing from the spirit and scope thereof.

What is claimed is:

1. A contact that electrically connects between an electrode of a fluorescent tube and a circuit board, comprising:
a base portion;
a contact portion that is brought into contact with the electrode of the fluorescent tube;
a connecting portion that is continuous with said base portion and is connected to the circuit board; and
a linkage portion that connects between said base portion and said contact portion such that said contact portion is movable in a longitudinal direction of the fluorescent tube,
said base portion, said linkage portion, and said contact portion being arranged in a first direction that is orthogonal to a direction perpendicular to a plane on which the circuit board extends and the longitudinal direction.

2. The contact as claimed in claim 1, wherein said linkage portion has a plate shape, and a thickness direction of said linkage portion is parallel to the longitudinal direction.

3. The contact as claimed in claim 2, wherein said linkage portion extends in the first direction, and a width of each end portion of said linkage portion is larger than a width of a central portion of said linkage portion.

4. The contact as claimed in claim 1, wherein the central portion of said linkage portion is bent.

5. The contact as claimed in claim 2, wherein the central portion of said linkage portion is bent.

6. The contact as claimed in claim 3, wherein the central portion of said linkage portion is bent.

7. A connector comprising:
a contact that electrically connects between an electrode of a fluorescent tube and a circuit board, including:
a base portion,
a contact portion that is brought into contact with the electrode of the fluorescent tube,
a connecting portion that is continuous with said base portion and is connected to the circuit board, and
a linkage portion that connects between said base portion and said contact portion such that said contact portion is movable in a longitudinal direction of the fluorescent tube,
said base portion, said linkage portion, and said contact portion being arranged in a first direction that is orthogonal to a direction perpendicular to a plane on which the circuit board extends and the longitudinal direction; and
a fixed housing that accommodates said contact and has said base portion fixed thereto.

8. The connector as claimed in claim 7, wherein the connecting portion has a clip shape that sandwiches the circuit board in a thickness direction of the circuit board, and
wherein the fixed housing has a board insertion portion that receives therein a portion of the circuit board.

9. The connector as claimed in claim 7, comprising a movable housing that is movably mounted to said fixed housing and adjusts a contact force between said contact portion and the electrode of the fluorescent tube.

10. The connector as claimed in claim 8, comprising a movable housing that is movably mounted to said fixed housing and adjusts a contact force between said contact portion and the electrode of the fluorescent tube.

11. The connector as claimed in claim 7, wherein said linkage portion has a plate shape, and a thickness direction of said linkage portion is parallel to the longitudinal direction.

12. The connector as claimed in claim 11, wherein said linkage portion extends in the first direction, and a width of each end portion of said linkage portion is larger than a width of a central portion of said linkage portion.

13. The connector as claimed in claim 7, wherein the central portion of said linkage portion is bent.
